(19) United States
(12) Patent Application Publication
(10) Pub. No.: US 2011/0001102 A1
(43) Pub. Date: Jan. 6, 2011

(54) BAND BRAKE

(75) Inventor: Brad E. Hossler, Tiffin, OH (US)

Correspondence Address: BARNES & THORNBURG LLP, P.O. Box 2786, CHICAGO, IL, 60690-2786, US

(73) Assignee: TIFFIN SCENIC STUDIOS, INC., Tiffin, OH (US)

(21) Appl. No.: 12/497,308

(22) Filed: Jul. 2, 2009

(51) Int. Cl. B66D 5/10

(52) U.S. Cl. 254/322

(57) ABSTRACT

A band brake for rotating machinery and equipment, in particular, a band brake for hoists, winches, and similar load lifting equipment. The band brake includes a resilient flexible band disposed about a rotatable drum, a tension bar pivotally coupled to a frame, a positioner attached to the frame and coupled with the tension bar to move the band brake between an engaged position and a disengaged position. The positioner includes a linear actuator, an articulated link assembly, and a magnetic retention assembly.

### BACKGROUND AND SUMMARY

The subject matter of the present disclosure relates to brakes for rotating machinery and equipment. In particular, the present disclosure relates to a band brake for hoists, winches, and similar rotating equipment.

One aspect of the brake includes a resilient flexible band disposed about a rotatable drum. The band has a first end fixed to a frame, and a movable second end, such that the band is capable of being configured to engage the rotatable drum and to disengage the rotatable drum. The band is engaged and disengaged by an actuator rod coupled to the band at the movable second end.

A tension bar, including a first end and a biased second end, is pivotally coupled to the frame. The actuator rod is attached to the tension bar at the first end and a bias assembly is attached to the tension bar at the biased second end. The bias assembly includes a pair of spring assemblies, with each spring assembly disposed on an opposite side of the tension bar.

Each spring assembly includes an upper spring support bracket fixed to the frame, a lower spring support bracket fixed to the tension bar, an adjustment pin, and a compression spring disposed about the adjustment pin between the upper spring support bracket and the lower spring support bracket. The adjustment pin allows for adjustable positioning of the compression spring to increase and decrease spring force.

A positioner attached to the frame and coupled with the tension bar at the biased second end is provided to move the brake of the present disclosure between an engaged position and a disengaged position. The positioner includes a linear actuator, an articulated link assembly, and a magnetic retention assembly.

The linear actuator is fixed to the frame and includes an actuator rod. The articulated link assembly includes a rod link having a first leg and a second leg. The first leg of rod link is pivotally coupled to the actuator rod. A hinged link is coupled to the second leg of the rod link and to the biased second end of the tension bar. The hinged link includes a first link arm pivotally coupled to the second leg of the rod link, the first link arm including a passage configured to allow the actuator rod to be disposed through the first link arm and a second link arm pivotally coupled to the biased second end of the tension bar, wherein the first link arm is pivotally coupled to the second link arm. A magnetic retention assembly includes an electromagnet fixed to the frame and a magnetic pad pivotally coupled to the positioner, wherein the magnetic retention assembly is configured to hold the band disengaged from the rotatable drum by maintaining the positioner in fixed relation to the frame.

### BRIEF DESCRIPTION OF THE DRAWINGS

The present disclosure will be described hereafter with reference to the attached drawings which are given as a non-limiting example only, in which:

FIG. 1 is a schematic representation of the band brake of the present disclosure, wherein the band brake is in a disengaged position allowing for operation of rotating equipment onto which it is attached;

FIG. 2 is a schematic representation of the band brake of the present disclosure, wherein the band brake is in an engaged position for locking the rotating equipment;

FIG. 3 is a front elevation view of an embodiment of the band brake of the present disclosure;

FIG. 4 is a section view of the band brake of FIG. 3 taken at 4-4;

FIG. 5 is a section view of the band brake of FIG. 3 taken at 5-5;

FIG. 6 is a front perspective view of the band brake of the present disclosure; and

FIG. 7 is a rear perspective view of the band brake of the present disclosure.

### DETAILED DESCRIPTION

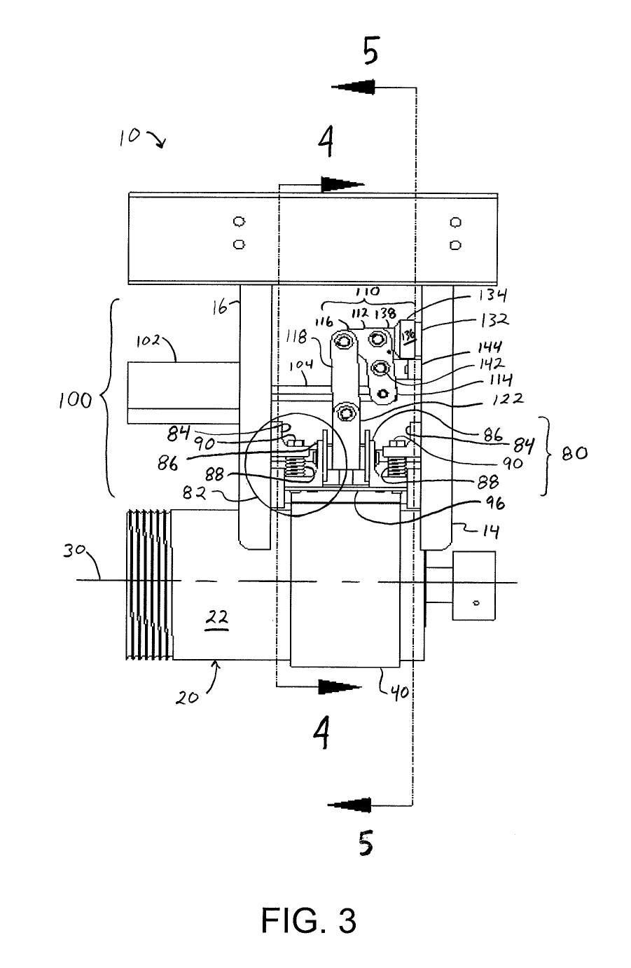

Referring to FIGS. 3-7, brake 10 of the present disclosure includes a frame 12 having a first frame member 14 and a second frame member 16. In the illustrated embodiment, first frame member 14 and second frame member 16 are positioned in parallel spaced-apart relation to each other for mounting components of brake 10 to a piece of rotating equipment or machinery such as a hoist, winch, or similar device.

Brake 10 is configured for cooperation with a drum 20 having a cylindrical shape and including an outer surface 22 and a hub 24. The hub having a bore 26 configured to receive a shaft 2 of a piece of rotating equipment. The bore 26 may be formed to include a keyway 28 configured for cooperation with a shaft key for rigidly coupling drum 20 to shaft 2. The drum 20 also defines a drum axis 30 along its cylindrical centerline. The shaft 2 is configured for connection to a driver, such as an electric motor, hydraulic motor, pneumatic motor, gear reducer, etc. for operation of the rotating equipment. In the exemplary embodiment as shown in FIGS. 3, 6, and 7, the drum 20 is integrally configured as part of a cable drum of a hoist. However, as should be apparent, drum 20 may be freestanding and may be positioned at any suitable location along shaft 2.

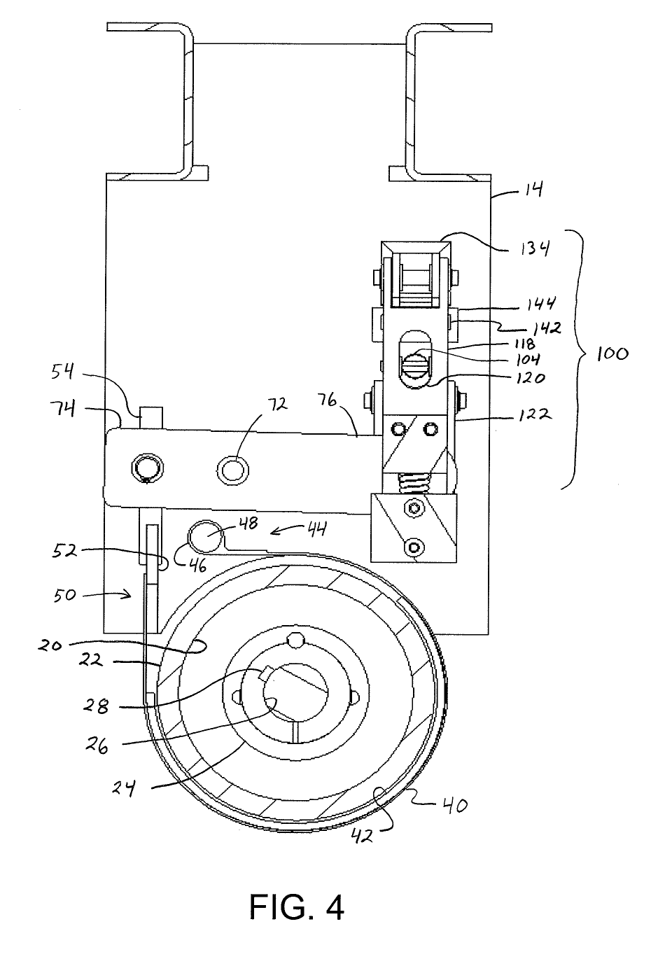

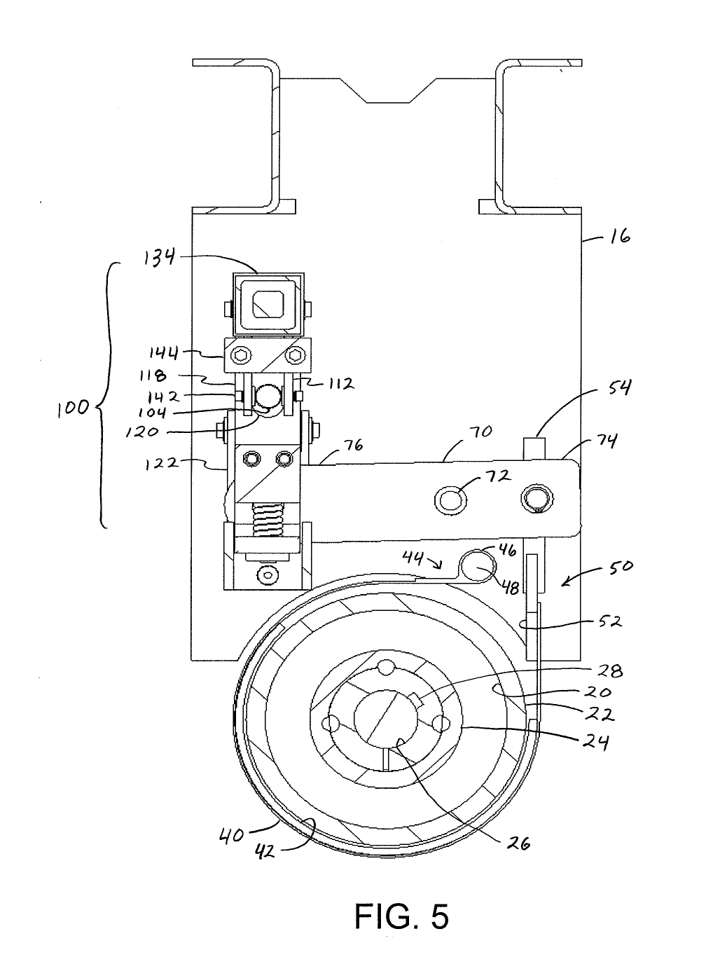

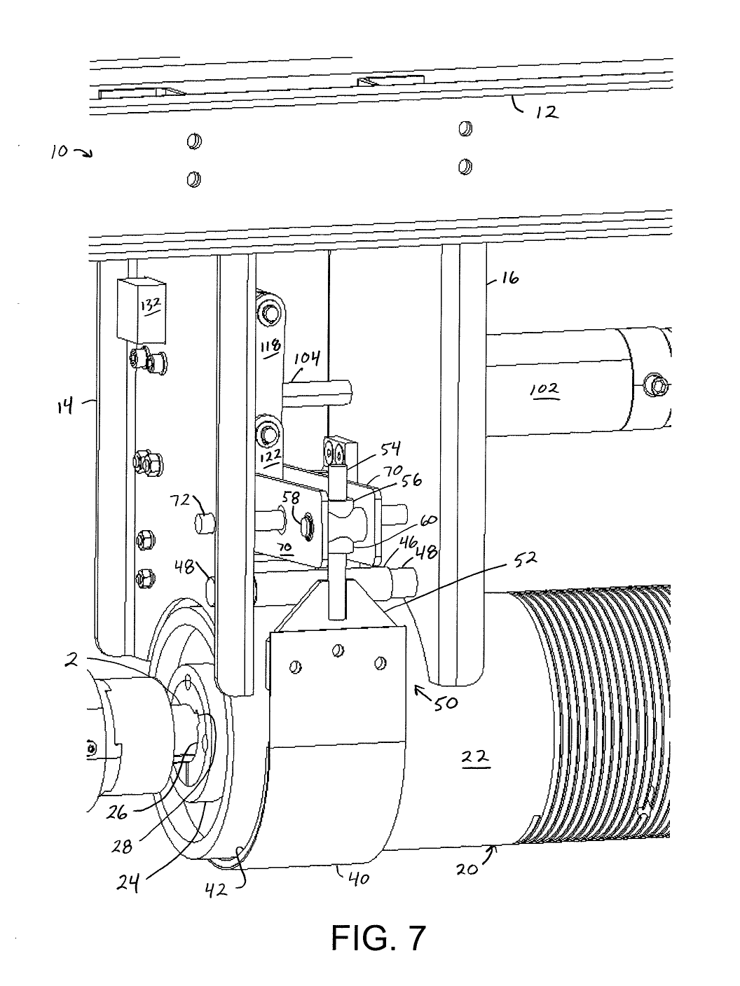

A brake band 40 is disposed about the drum 20 and configured to engage drum 20 to prevent rotation. Brake band 40 is constructed of a resilient flexible material such as steel or aluminum. Brake band 40 further includes a friction lining 42 disposed on a surface of the brake band 40 adjacent the drum 20. A first end 44 of the brake band 40 includes a link 46, as shown in FIGS. 4 and 5. The link 46 is configured for fixed attachment to the frame by a band link pin 48. Referring to FIG. 7, a second 50 end of the brake band 40 includes an adapter plate 52, which is coupled to the brake band 40 and to a band actuator 54. Band actuator 54 is coupled to a tension bar 70 by an actuator yoke 56, which includes an axle 58 and a sleeve 60 configured to receive band actuator 54.

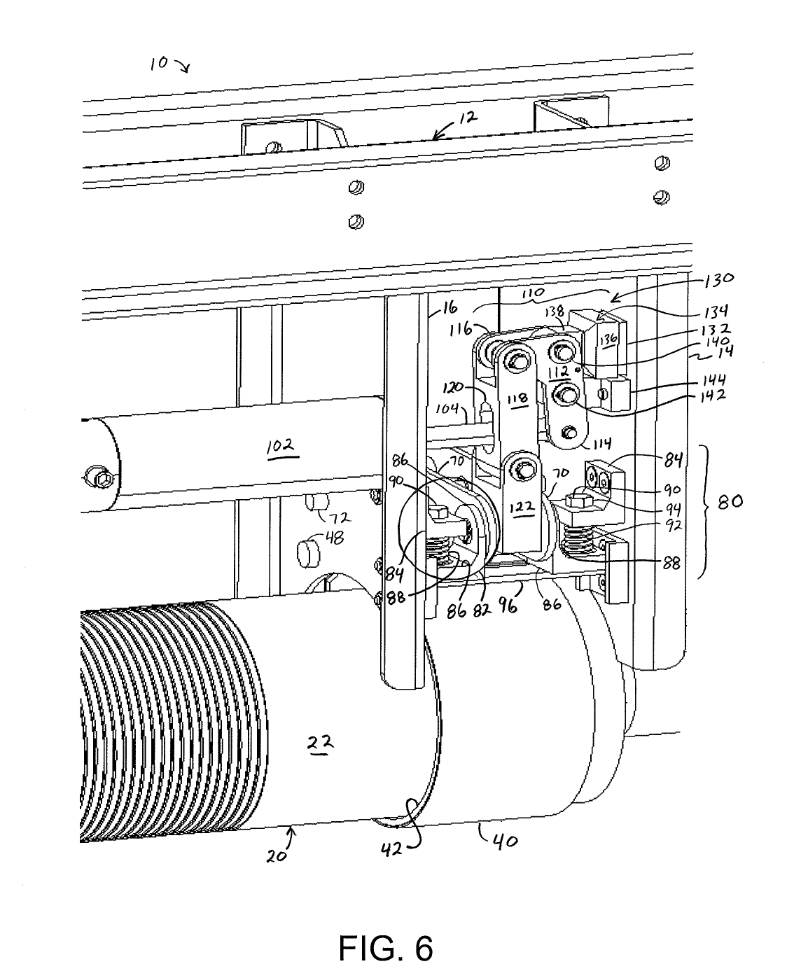

Tension bar 70 is pivotally coupled to the frame 12 by a tension bar pivot rod 72. Tension bar 70 includes a first end 74 pivotally coupled to band actuator 54 by actuator yoke 56. Tension bar 70 also includes a second end 76 having a bias assembly 80, as shown in FIGS. 3 and 6. Tension bar 70 is biased so that the normal at-rest, de-energized, position of the brake 10 of the present disclosure, tension bar 70 exerts an upward force on band actuator 54 causing brake band 40 to engage drum 20, thus preventing rotation of the drum 20 and the shaft 2 of the rotating equipment to which the drum 20 is coupled.

In the exemplary embodiment, the bias assembly 80 includes a pair of spring assemblies 82 disposed on either side of the tension bar 70 and attached to frame members 14, 16. Each spring assembly 82 includes an upper spring support bracket 84 attached to one of the frame members 14, 16, a lower spring support bracket 86 attached to the tension bar 70, and a compression spring 88 disposed between the upper 84 and lower 86 support brackets. Each spring assembly 82 also includes an adjustment pin 90. In the embodiment shown, adjustment pin 90 includes a threaded rod 92 and an adjustment nut 94. As spring force is proportional to spring displacement, the force exerted by the spring 88 may be increased or decreased by decreasing or increasing the distance between the upper 84 and lower 86 support brackets, respectively. In the illustrated embodiment, threaded rod 92 is fixed to lower support bracket 86. A helical compression spring 88 is disposed about threaded rod 92 and secured between upper 84 and lower 86 spring support brackets. Adjustment nut 94 is engaged onto threaded rod 92, wherein tightening down on adjustment nut 94 compresses spring 88 between upper 84 and lower 86 support brackets. As upper 84 and lower 86 spring support brackets are forced closer together, spring 88 is compressed. The greater the spring compression, the greater the force exerted on tension bar 70. Bias assembly 80 may also include a stabilizer 96 coupled to each spring assembly 82. Stabilizer 96 aids in distributing the forces produced by the spring assemblies 82, reducing lateral torsion forces on tension bar 70.

The brake of the present disclosure further includes a positioner 100 for engaging and disengaging the brake band 40 about the drum 20 as illustrated in FIGS. 3-6. Positioner 100 includes a linear actuator 102 and an actuator rod 104 extending outwardly from the linear actuator 102. As in the illustrative embodiment, the linear actuator may be a hydraulic cylinder having a piston (not shown) enclosed within the hydraulic cylinder for moving the actuator rod 104 by means of hydraulic pressure. Also, as shown in FIGS. 3, 6, and 7 of the illustrative embodiment, the linear actuator 102 is attached to the frame 12 ant the second frame member 16. Other acceptable linear actuators include pneumatic cylinders or electromechanical linear actuators such as magnetically coupled cylinders.

Referring to FIG. 6, actuator rod 104 is pivotally coupled to an articulated link assembly 110, which is coupled to the tension bar 70. Articulated link assembly 110 includes a rod link 112 pivotally coupled to the actuator rod 104 at a first leg 114. At a second leg 116, the rod link 112 is pivotally coupled to first link arm 118. The first link arm 118 includes a passage 120 allowing the actuator rod 104 to pass through first link arm 118. First link arm 118 is pivotally coupled to a second link arm 122, which is fixed to tension bar 70 at the second end 76.

The brake 10 of the present disclosure further includes a magnetic retention assembly 130, configured to retain brake band 40 disengaged from drum 20 during normal operation, shown in FIGS. 3 and 6. This feature reduces the amount of work required from the linear actuator 102 and reduces the likelihood that the linear actuator 102 will overload and shut down during normal operation, thus locking the brake. The magnetic retention assembly 130 includes an electromagnet 132 and a magnetic pad 134.

In the illustrated embodiment, the rod link 112 is configured in an inverted L-shape with one leg 114 pivotally coupled to the actuator rod 104 and the other leg 116 pivotally coupled to one end of the first link arm 118. Rod link 112 is pivotally attached to the frame 12 by a rod link mount 144, which includes pivot pin 142.

Magnetic pad 134 is pivotally coupled to the elbow of the L-shaped link arm. Magnetic pad 134 includes a body 136 and a lug 138. The lug 138 defines an aperture configured to receive a link pin 140 for pivotally coupling magnet pad 134 to the first link arm 118. The body 136 of the magnet pad 134 is composed of magnetic material such as steel, iron, or other ferrous material. Magnet pad 134 is configured to cooperate with an electromagnet 132 attached to frame member 14.

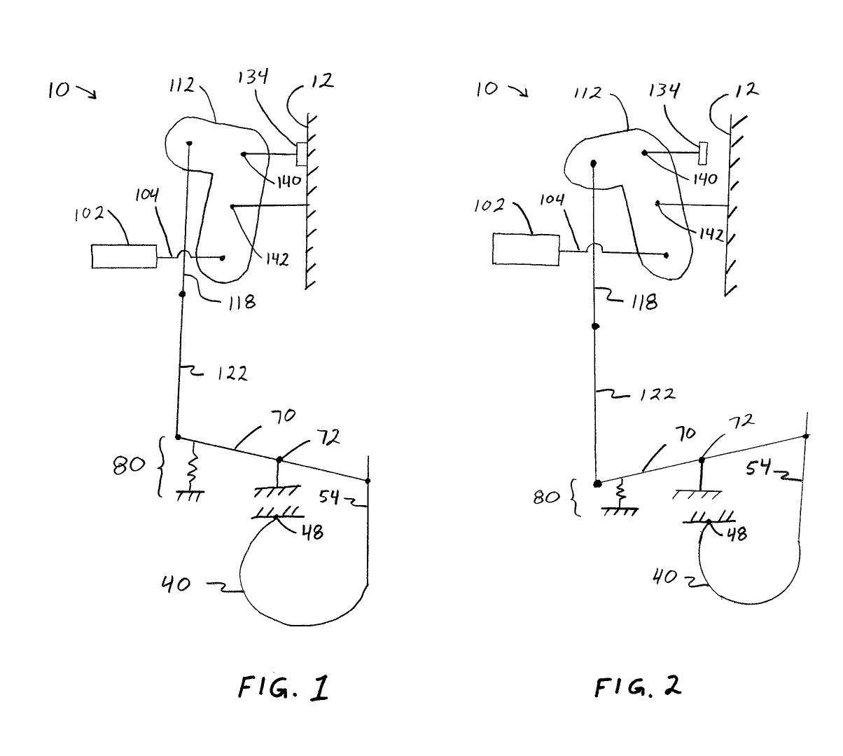

Operation of the brake 10 of the present disclosure includes a disengaged configuration shown schematically in FIG. 1, and an engaged configuration, shown schematically in FIG. 2. When the rotating equipment is in operation, the brake 10 of the present disclosure is disengaged, that is, brake band 40 is out of contact with drum 20, which allows drum 20 and shaft 2 to rotate freely. In operation, a control system provides a signal that causes electrical power to be supplied to electromagnet 132. The control system also provides a signal to linear actuator 102 to retract actuator rod 104. In the exemplary embodiment wherein the linear actuator is shown as a hydraulic cylinder, a pump or other means provides differential pressure within the hydraulic cylinder to move the actuator rod.

Linear actuator 102 retracts actuator rod 104 causing rod link 112 to rotate about pivot pin 142, drawing link arms 118 and 122 upward. Tension bar 70 rotates about pivot rod 72, forcing band actuator 54 downward, releasing brake band 40 from engagement with drum 20. When actuator rod 104 is in the fully retracted position, magnet pad 134 is in contact with and held fixed by electromagnet 132. In this configuration, link pin 140 is fixed relative to pivot pin 142, which is fixed to frame 12, thus preventing rotation of rod link 112. Brake 10 of the present disclosure may now be held in a disengaged or operating configuration without operation of the linear actuator 102. Thus, operation of the linear actuator 102 is only required for the initial process of disengaging brake 10, and not during continuous operation of the rotating equipment.

To engage the brake 10, the control system provides a signal de-energizing electromagnet 132. The control system also provides a signal to linear actuator 102 to extend actuator rod 104. With electromagnet 132 de-energized, magnet pad 134 is no longer held fixed and rod link 112 is free to rotate about pivot pin 142, driving link arms 118, 122 downward. Tension bar 70 rotates about pivot rod 72, pulling up on band actuator 54 engaging the brake band 40 about drum 20, locking drum 20 and the shaft 2 to which it is coupled.

The brake 10 of the present disclosure includes a fail-safe feature that engages the brake band 40 about drum 20 upon loss of electrical power, preventing any load carried by the equipment from free falling. Upon loss of electrical power, electromagnet 132 de-energizes releasing rod link 112. Tension bar 70 being biased by spring assemblies 82, rotates about pivot rod 72, drawing up band actuator 54, engaging brake band 40 about drum 20, locking the drum 20 and shaft 2.

The band brake 10, as disclosed herein, provides a compact configuration particularly suited for incorporation into a hoist, or other rotating equipment wherein space is a premium. Further, in the brake 10 of the present disclosure the linear actuator is only required for initial and final positioning of the brake, and not during normal operation. The magnetic retention assembly holds the brake in a normal operating configuration and allows for fail-safe operation.

The foregoing is considered as illustrative only of the principles of the claimed invention. Further, since numerous modifications and changes will readily occur to those skilled in the art, it is not desired to limit the claimed invention to the exact construction and operation shown and described, and accordingly, all suitable modifications and equivalents may be resorted to, falling within the scope of the claimed invention.

1. A band brake apparatus for locking a rotatable drum, the band brake comprising:
a resilient flexible band for disposition about the rotatable drum, the band having a first end fixed to a frame, and a movable second end, the band being capable of being configured to engage the rotatable drum and to disengage the rotatable drum;
a band actuator coupled to the band at the movable second end;
a tension bar pivotally coupled to the frame, the tension bar including a first end and a biased second end, wherein the band actuator is attached to the tension bar at the first end and a bias assembly is attached to the tension bar at the biased second end;
a positioner attached to the frame and coupled with the tension bar at the biased second end; and
a magnetic retention assembly including
an electromagnet fixed to the frame, and
a magnetic pad coupled to the positioner,
wherein the magnetic retention assembly is configured to hold the band disengaged from the rotatable drum by maintaining the positioner in fixed relation to the frame.

2. The band brake apparatus of claim 1 wherein the positioner comprises
a linear actuator fixed to the frame and including an actuator rod; and
an articulated link assembly including
a rod link pivotally coupled to the frame and having a first leg and a second leg, the first leg of rod link being pivotally coupled to the actuator rod, and
a hinged link coupled to the second leg of the rod link and coupled to the biased second end of the tension bar.

3. The band brake apparatus of claim 1 wherein the magnetic pad is pivotally coupled to the rod link.

4. The band brake of claim 2 wherein the hinged link comprises:
a first link arm pivotally coupled to the second leg of the rod link; and
a second link arm pivotally coupled to the biased second end of the tension bar, wherein the first link arm is pivotally coupled to the second link arm.

5. The band brake apparatus of claim 2 wherein the hinged link further includes a passage configured to allow the actuator rod to be disposed through the hinged link.

6. The band brake apparatus of claim 5 wherein the passage is disposed in the first link arm.

7. The band brake apparatus of claim 2 wherein the linear actuator comprises a hydraulic cylinder.

8. The band brake apparatus of claim 1 wherein the bias assembly comprises:
an upper spring support bracket fixed to the frame;
a lower spring support bracket fixed to the tension bar;
an adjustment pin; and
a compression spring disposed about the adjustment pin between the upper spring, support bracket, and the lower spring support bracket, wherein the adjustment pin allows for adjustable positioning of the compression spring to increase and decrease spring force.

9. The band brake apparatus of claim 8 wherein the bias assembly further comprises a pair of spring assemblies, each spring assembly disposed on an opposite side of the tension bar, each spring assembly comprising
an upper spring support bracket fixed to the frame;
a lower spring support bracket fixed to the tension bar;
an adjustment pin;
a compression spring disposed about the adjustment pin between the upper spring support bracket and the lower spring support bracket, wherein the adjustment pin allows for adjustable positioning of the compression spring to increase and decrease spring force; and
a stabilizer coupled to each of the pair of spring assemblies.

10. The band brake apparatus of claim 1 wherein the actuator rod is oriented in a first direction and the tension bar is oriented in a second direction, wherein the first direction is perpendicular to the second direction.

11. A band brake apparatus for locking a rotatable drum, the band brake comprising:
a resilient flexible band for disposition about the rotatable drum, the band having a first end fixed to a frame, and a movable second end, the band being capable of being configured to engage the rotatable drum and to disengage the rotatable drum;
a band actuator coupled to the band at the movable second end;
a tension bar pivotally coupled to the frame, the tension bar including a first end and a biased second end, wherein the band actuator is attached to the tension bar at the first end and a bias assembly is attached to the tension bar at the biased second end, the bias assembly comprising
an upper spring support bracket fixed to the frame,
a lower spring support bracket fixed to the tension bar,
an adjustment pin, and
a compression spring disposed about the adjustment pin between the upper spring support bracket and the lower spring support bracket, wherein the adjustment pin allows for adjustable positioning of the compression spring to increase and decrease spring force; and
a positioner attached to the frame and coupled with the tension bar at the biased second end, the positioner comprising
a linear actuator fixed to the frame and including an actuator rod,
an articulated link assembly including
a rod link pivotally coupled to the frame and having a first leg and a second leg, the first leg of the rod link being pivotally coupled to the actuator rod, and
a hinged link coupled to the second leg of the rod link and coupled to the biased second end of the tension bar, and
a magnetic retention assembly including
an electromagnet fixed to the frame, and
a magnet pad coupled to the positioner
wherein the magnetic retention assembly is configured to hold the band disengaged from the rotatable drum by maintaining the positioner in fixed relation to the frame.

12. The band brake apparatus of claim 11 wherein the hinged link further includes a passage configured to allow the actuator rod to be disposed through the hinged link.

13. The band brake apparatus of claim 12 wherein the passage is disposed in the first link arm.

14. The band brake apparatus of claim 11 wherein the bias assembly comprises a pair of spring assemblies, each spring assembly disposed on an opposite side of the tension bar, each spring assembly comprising
an upper spring support bracket fixed to the frame;
a lower spring support bracket fixed to the tension bar;
an adjustment pin;
a compression spring disposed about the adjustment pin between the upper spring support bracket and the lower spring support bracket, wherein the adjustment pin allows for adjustable positioning of the compression spring to increase and decrease spring force; and
a stabilizer coupled to each of the pair of spring assemblies.

15. The band brake apparatus of claim 11 wherein the actuator rod is oriented in a first direction and the tension bar is oriented in a second direction, wherein the first direction is perpendicular to the second direction.

16. A band brake apparatus for locking a rotatable drum, the band brake comprising:
a resilient flexible band for disposition about the rotatable drum, the band having a first end fixed to a frame, and a movable second end, the band being capable of being configured to engage the rotatable drum and to disengage the rotatable drum;
a band actuator coupled to the band at the movable second end;
a tension bar pivotally coupled to the frame, the tension bar including a first end and a biased second end, wherein the band actuator is attached to the tension bar at the first end and a bias assembly is attached to the tension bar at the biased second end, the bias assembly including
a pair of spring assemblies, each spring assembly disposed on an opposite side of the tension bar, each spring assembly comprising
an upper spring support bracket fixed to the frame;
a lower spring support bracket fixed to the tension bar;
an adjustment pin, and
a compression spring disposed about the adjustment pin between the upper spring support bracket and the lower spring support bracket, wherein the adjustment pin allows for adjustable positioning of the compression spring to increase and decrease spring force;
a positioner attached to the frame and coupled with the tension bar at the biased second end, the positioner comprising
a linear actuator fixed to the frame and including an actuator rod;
an articulated link assembly including
a rod link pivotally coupled to the frame and having a first leg and a second leg, the first leg of rod link being pivotally coupled to the actuator rod; and
a hinged link coupled to the second leg of the rod link and coupled to the biased second end of the tension bar, the hinged link comprising
a first link arm pivotally coupled to the second leg of the rod link, the first link arm including a passage configured to allow the actuator rod to be disposed through the first link arm, and
a second link arm pivotally coupled to the biased second end of the tension bar, wherein the first link arm is pivotally coupled to the second link arm; and
a magnetic retention assembly including
an electromagnet fixed to the frame, and
a magnetic pad pivotally coupled to the positioner
wherein the magnetic retention assembly is configured to hold the band disengaged from the rotatable drum by maintaining the positioner in fixed relation to the frame.

17. The band brake apparatus of claim 16 wherein the linear actuator is a hydraulic cylinder.

18. The band brake apparatus of claim 16 wherein the linear actuator is a pneumatic cylinder.

19. The band brake apparatus of claim 16 wherein the linear actuator is an electromechanical linear actuator.

20. The band brake apparatus of claim 19 wherein the electromechanical linear actuator is a magnetically coupled cylinder.
